(19) United States
(12) Patent Application Publication
(10) Pub. No.: US 2015/0143666 A1
(43) Pub. Date: May 28, 2015

(54) Closing sequence control for a double-leaf door

(71) Applicant: DORMA Deutschland GmbH, Ennepetal (DE)

(72) Inventor: Bernd WINKLER, Breckerfeld (DE)

(21) Appl. No.: 14/549,858

(22) Filed: Nov. 21, 2014

(30) Foreign Application Priority Data
Nov. 22, 2013 (DE) 102013112946.3

(51) Int. Cl. E05D 15/30; E05D 15/26

(52) U.S. Cl. CPC E05D 15/30; E05D 15/262
USPC 16/235

(57) ABSTRACT

The present invention relates to a closing sequence control for a double-leaf door, including a door having an inactive leaf and an active leaf, the door leaves thereof being movable by respectively one overhead door closer being mounted to the push-side of the door leaves at the inactive leaf and at the active leaf, wherein each overhead door closer includes a closer shaft, which is connected to the one end of a pivoting arm, which in turn, with its other end, is longitudinally movable guided in a frame-fixed guiding rail via a sliding member, and the sliding member, associated to the active leaf, is connected to a clamping rod which is supported in the guiding rail, which rod can be charged by a clamping element, which, when the inactive leaf is in the closing condition, is maintained in a releasing position by means of a trigger element, and, during an opening movement of the inactive leaf, it can be transferred into a blocking position by means of the trigger element. With the intention to configure such a closing sequence control in such a way that the door hinges of the door leaves can be disposed on the side facing away from the door closers, the guiding rail and the closing sequence control, wherein a reliable closing sequence control can be guaranteed without electrical, hydraulic or pneumatic control, according to the invention it is provided that the trigger element (8) is in operative connection with a double-armed lever (11), which can be charged by means of the closer shaft (5) of the overhead door closer (3) mounted to the inactive leaf (1) in such a way that the trigger element (8) transfers the blocking element (8) into its releasing position.

### CROSS REFERENCE TO RELATED APPLICATION

This application is related to and claims the benefit of German Patent Application Number DE102013112946.3 filed 22 Nov. 2013, the contents of which are herein incorporated by reference in their entirety.

### TECHNICAL FIELD

The present invention relates to a closing sequence control for a double-leaf door, including a door having an inactive leaf and an active leaf, the door leaves thereof being movable by respectively one overhead door closer being mounted to the push-side of the door leaves at the inactive leaf and at the active leaf, wherein each overhead door closer includes a closer shaft, which is connected to the one end of a pivoting arm, which in turn, with its other end, is longitudinally movable guided in a frame-fixed guiding rail via a sliding member, and the sliding member, associated to the active leaf, is connected to a clamping rod which is supported in the guiding rail, which rod can be charged by a clamping element, which, when the inactive leaf is in the closing condition, is maintained in a releasing position by means of a trigger element, and, during an opening movement of the inactive leaf, it can be transferred into a blocking position by means of the trigger element.

### BACKGROUND

Generally, such closing sequence controls are known. They ensure that the inactive leaf is closed prior to the active leaf and that thus a complete, tight closing of the door is guaranteed. The correct closing sequence can be achieved for example by means of a push rod clamped blocking. In this case, the active leaf can be freely moved when the inactive leaf is closed. If, however both door leaves are opened, the active leaf is held open by means of the closing sequence control for so long until the inactive leaf has been completely closed.

This known closing sequence control has been tried and tested to be reliable everywhere, where a pull-side mounting of the door closers is realized, in which the door hinges are disposed on the same door side as the door closer as well as the guiding rail and the closing sequence control.

However, if with double-leaf doors, the door hinges are located on the opposite side of the door closer, of the guiding rail and of the closing sequence control, during an opening movement of the door leaf and resulting from geometrical conditions, initially the sliding members at the pivoting arms of the door closers slightly move in the direction of the lock and only thereafter in the direction of the pull-side of the door leaves. This circumstance could lead to jamming of the known closing sequence control such that the desired functioning is not always reliably achieved.

### BRIEF SUMMARY

Therefore, the invention provides a closing sequence control of the species mentioned in the introduction in such a way that the door hinges of the door leaves can be disposed on the side facing away from the door closers, the guiding rail and the closing sequence control, wherein a reliable closing sequence control can be guaranteed without electrical, hydraulic or pneumatic control.

This problem is solved with a closing sequence control for a double-leaf door, including a door having an inactive leaf and an active leaf, the door leaves thereof being movable by respectively one overhead door closer being mounted to the push-side of the door leaves at the inactive leaf and at the active leaf, wherein each overhead door closer includes a closer shaft, which is connected to the one end of a pivoting arm, which in turn, with its other end, is longitudinally movable guided in a frame-fixed guiding rail via a sliding member, and the sliding member, associated to the active leaf, is connected to a clamping rod which is supported in the guiding rail, which rod can be charged by a clamping element, which, when the inactive leaf is in the closing condition, is maintained in a releasing position by means of a trigger element, and, during an opening movement of the inactive leaf, it can be transferred into a blocking position by means of the trigger element, according to the invention in that the trigger element is in operative connection with a double-armed lever, which can be charged by the closer shaft of the overhead door closer mounted to the inactive leaf in such a way that the trigger element transfers the blocking element into its release position.

Instead of being charged by means of the closer shaft, a charging by means of the end of the pivoting arm connected to the closer shaft is likewise conceivable.

As a result of this embodiment, a closing sequence control can be provided with simple means, in which a slight movement of the siding member in the direction of the lock is irrelevant, such that the desired functioning can be reliably guaranteed.

Advantageous further developments of the invention are the subject matter of the dependent claims.

According to an advantageous further development, the double-armed lever is held at a bearing block, which is disposed at the guiding rail.

Advantageously, the bearing block is configured as a U-shaped bracket, the open side thereof facing the overhead door closer.

According to one preferred embodiment, the double-armed lever is pivotally supported at the frontal side of the one leg of the U-shaped bracket. Advantageously, a bearing bore is configured in the other leg of the U-shaped bracket, in which bore the trigger element is slidably guided.

According to a preferred further development, the trigger element includes an essentially rectangular protruding arm, which is disposed between the legs of the U-shaped bearing block and protrudes beyond them.

Advantageously, the arm can be charged at its protruding end by means of the double-armed lever.

According to an advantageous embodiment, the arm is provided with a pin-shaped extension at its end protruding beyond the legs of the U-shaped bearing block.

Advantageously, the two arms of the double-armed lever are disposed at an angle with regard to each other, preferably at an angle comprised between approximately 90° and 180°.

According to a preferred embodiment, the one arm of double-armed lever abuts at the pin-shaped extension, while the other arm of the double-armed lever can be charged by means of the closer shaft.

### BRIEF DESCRIPTION OF THE DRAWINGS

Further details, features and advantages of the invention will become apparent from the following description, reference being made to the drawings, in which:

FIG. 1 shows a double-leaf door including an inactive leaf and an active leaf having a closing sequence control in a slightly opened position,

FIG. 2 shows the door according to FIG. 1 in the area of the slightly opened inactive leaf,

FIG. 3 shows the door according to FIG. 1 in the upper area of the completely closed inactive leaf, and

FIG. 4 shows the door according to FIG. 1 in the upper area of the completely closed active leaf.

### DETAILED DESCRIPTION

In the following description and in the figures, the door, the door closer thereof, and the closing sequence control will be explained and illustrated only in the context which is relevant herein. In particular the elements of the closing sequence control, disposed in the guiding rail, will not be dealt with, but considered as already known.

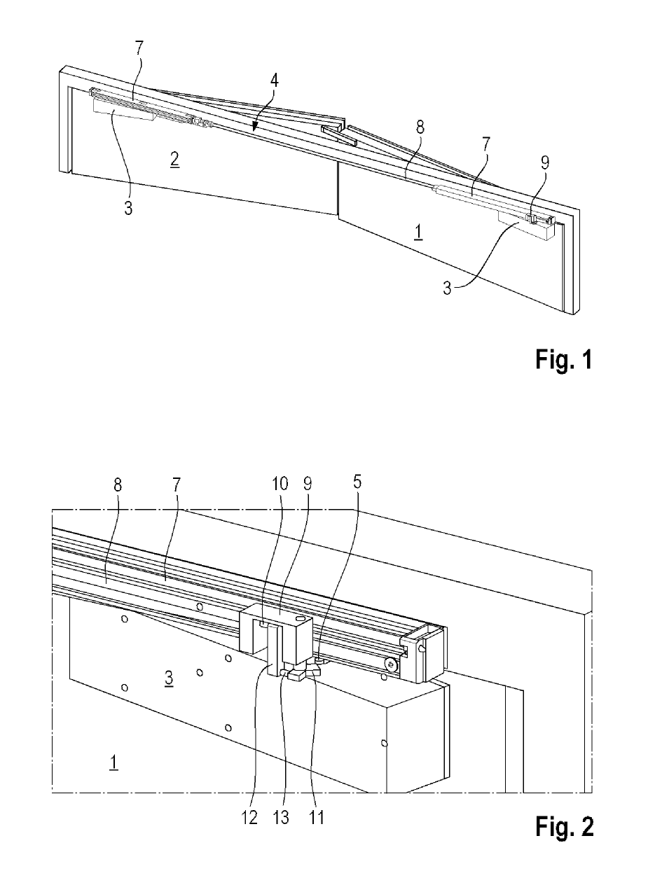

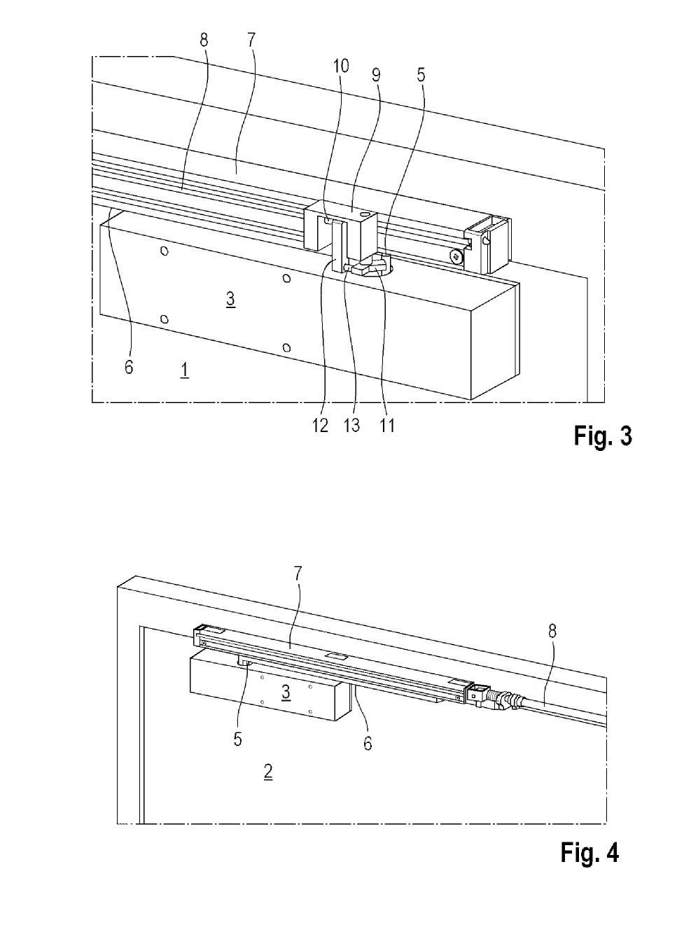

FIG. 1 shows a double-leaf door including an inactive leaf 1 and an active leaf 2. In the upper area of the inactive leaf 1 and of the active leaf 2, respectively one overhead door closer 3 as well as a closing sequence control 4 are disposed on the push-side.

Each overhead door closer 3 includes a closer shaft 5, which is connected to the one end of a pivoting arm 6, which, with its other end and via a siding member, is longitudinally movable guided in a frame-fixed guiding rail 7. The siding member associated to the active leaf 2 is connected to a clamping rod which is supported in the guiding rail 7 and charged by means of a clamping element. In the closing condition of the inactive leaf 1, the clamping element is retained by means of a trigger element 8 in a releasing position, and during an opening movement of the inactive leaf 1, it can be transferred into a blocking position by means of the trigger element 8, in which position the active leaf 2 is immobilized.

In the present case, the trigger element 8 is configured as a rod and extends between the two guiding rails 7. In the area of the inactive leaf 1, the trigger element 8 is supported in a bearing block 9, which is disposed at the guiding rail 7 of the inactive leaf.

The bearing block 9 is configured as a U-shaped bracket, the open side thereof facing the overhead door closer 3. A bearing bore 10 is configured in the one leg of the U-shaped bracket, in which bore the trigger element 8 is slidably guided. At the frontal side of the other leg of the U-shaped bracket, a double-armed lever 11 is pivotally supported, which is in an operative connection with the trigger element 8.

The trigger element 8 includes an essentially rectangular protruding arm 12, which is disposed between the legs of the U-shaped bearing block 9 and protrudes beyond them. The arm 12 is provided with a pin-shaped extension 13 at its end protruding beyond the legs of the U-shaped bearing block 9, at which extension the double-armed lever 11 abuts.

The two arms of the double-armed lever 11 are disposed at an angle with regard to each other and include for example an angle comprised between 90° and 180°.

The arrangement is made in that the one arm of the double-armed lever 11 abuts at the pin-shaped extension 13, and in that the other arm can be charged by means of the closer shaft 5 of the overhead door closer 3 at the side of the inactive leaf.

This closing sequence control operates as follows:

With the inactive leaf 1 being closed, the active leaf 2 can be freely opened and closed. In this condition, the double-armed lever 11 abuts at the closer shaft 5, respectively at the end of the pivoting arm 6 connected to the closer shaft 5. However, as the inactive leaf 1 is opened, the double-armed lever 11 moves away from the closer shaft 5, whereby the closing sequence control is activated and the active leaf 2 is maintained in an opened position. Thus, in the opened condition of the inactive leaf 1, the double-armed lever 11 and the associated closer shaft 5 are not in contact. As soon as the inactive leaf 1 has reached its completely closed terminal position, the double-armed lever 11 reaches again contact with the closer shaft 5, respectively with the end of the pivoting arm 6 connected to the closer shaft 5. The double-armed lever 11 is thereby pivoted in the direction of the pin-shaped extension 13, and the extension 13, the arm 12 and the trigger element 8 are moved to the left side (in the Figures). The active leaf 2 is thereby released and can now be closed by means of the overhead door closer 3.

The preceding description of the present invention serves for illustrative purposes only and is not intended to limit the invention. Various changes and modifications are possible within the range of the invention without leaving the scope of the invention or the equivalents thereof.

1. A closing sequence control for a double-leaf door, including a door having an inactive leaf and an active leaf, the door leaves thereof being movable by respectively one overhead door closer being mounted to the push-side of the door leaves at the inactive leaf and at the active leaf, wherein each overhead door closer includes a closer shaft, which is connected to the one end of a pivoting arm, which, with its other end, is longitudinally movable guided in a frame-fixed guiding rail via a sliding member, and the sliding member, associated to the active leaf, is connected to a clamping rod which is supported in the guiding rail, which rod can be charged by a clamping element, which element, when the inactive leaf is in the closing condition, is maintained in a releasing position by means of a trigger element, and, during an opening movement of the inactive leaf, it can be transferred into a blocking position by means of the trigger element, wherein the trigger element is in operative connection with a double-armed lever, which can be charged by means of the closer shaft of the overhead door closer mounted to the inactive leaf in such a way that the trigger element transfers the blocking element into its releasing position.

2. The closing sequence control according to claim 1, wherein the double-armed lever is retained at a bearing block which is disposed at the guiding rail.

3. The closing sequence control according to claim 2, wherein the bearing block is configured as a U-shaped bracket, the open side thereof facing the overhead door closer.

4. The closing sequence control according to claim 3, wherein the double-armed lever is pivotally supported at the frontal side of the one leg of the U-shaped bracket.

5. The closing sequence control according to claim 4, wherein a bearing bore is provided in the other leg of the U-shaped bracket, in which bore the trigger element is slidably guided.

6. The closing sequence control according to claim 3, wherein the trigger element includes an essentially rectangular protruding arm, which is disposed between the legs of the U-shaped bearing block and protrudes beyond them.

7. The closing sequence control according to claim 6, wherein, at its protruding end, the arm is charged by means of the double-armed lever.

8. The closing sequence control according to claim 7, wherein, at its end protruding beyond the legs of the U-shaped bearing block, the arm is provided with a pin-shaped extension.

9. The closing sequence control according to claim 1, wherein the two arms of the double-armed lever are disposed at an angle with regard to each other.

10. The closing sequence control according to claim 8, wherein the one arm of the double-armed lever abuts at the pin-shaped extension, and the other arm of the double-armed lever can be charged by means of the closer shaft.
